(19) United States
(12) Patent Application Publication
(10) Pub. No.: US 2020/0007926 A1
(43) Pub. Date: Jan. 2, 2020

(54) METHOD AND APPARATUS FOR PLAYING VIDEO

(71) Applicant: Baidu Online Network Technology (Beijing) Co., Ltd, Beijing (CN)

(72) Inventors: Huan Tang, Beijing (CN); Peng Yuan, Beijing (CN); Haiguang Yuan, Beijing (CN); Liangcheng Wu, Beijing (CN)

(21) Appl. No.: 16/351,134

(22) Filed: Mar. 12, 2019

(30) Foreign Application Priority Data
Jun. 29, 2018 (CN) 201810714342.8

(51) Int. Cl. H04N 21/433; H04N 21/845; H04N 21/239; H04N 21/422; H04N 21/439

(52) U.S. Cl. CPC H04N 21/4333; H04N 21/8455; H04N 21/4394; H04N 21/42203; H04N 21/2393

(57) ABSTRACT

Embodiments of the present disclosure disclose a method and apparatus for playing a video. A specific embodiment of the method includes: in response to detecting a target video is played to an image frame associated with a time node, pausing the playing of the target video, the target video being acquired from a server by a smart device in response to receiving a video playing voice command in a form of voice; sending to the server a request for acquiring voice interactive content corresponding to the time node; receiving the voice interactive content returned by the server; and playing the received voice interactive content. According to the embodiment, the interactive interaction with the user performed through a dialogue is implemented during the playing of the video.

### CROSS-REFERENCE TO RELATED APPLICATIONS

This application claims priority to Chinese Patent Application No. 201810714342.8, filed with the China National Intellectual Property Administration (CNIPA) on Jun. 29, 2018, the content of which is incorporated herein by reference in its entirety.

### TECHNICAL FIELD

Embodiments of the present disclosure relate to the field of computer technology, and specifically to a method and apparatus for playing a video.

### BACKGROUND

Artificial Intelligence (abbreviated as AI) is a new technical science of researching and developing the theory, method, technique, or application system for simulating, extending and expanding human intelligence. Artificial intelligence is a branch of computer science, and attempts to understand the essence of intelligence and produce a new intelligent machine (also referred to as smart device) that capable of responding in a manner similar to human intelligence. Research in this area includes robotics, speech recognition, image recognition, natural language processing and expert system.

The smart device may interact with a user through a natural language dialogue, acquire a voice input of the user, report the input to a server, and receive a command returned by the server to perform a corresponding operation, for example, video playing, weather querying, or daily management.

During the playing of a video, most of the existing smart devices may support the general operations such as fast-forward, fast-reverse, play, and pause.

### SUMMARY

Embodiments of the present disclosure provide a method and apparatus for playing a video.

In a first aspect, the embodiments of the present disclosure provide a method for playing a video applied on a smart device. The method includes: pausing, in response to detecting a target video being played to an image frame associated with a time node, playing of the target video, the target video being acquired by a smart device from a server in response to receiving a video playing voice command in a form of voice; sending to the server a request for acquiring voice interactive content corresponding to the time node; receiving the voice interactive content returned by the server; and playing the received voice interactive content.

In some embodiments, the method further includes: receiving voice feedback of a user on the played voice interactive content; determining whether the voice feedback satisfies a preset condition; and continuing, in response to determining the voice feedback satisfying the preset condition, the playing of the target video.

In some embodiments, the method further includes: performing a preset operation, in response to determining the voice feedback not satisfying the preset condition.

In some embodiments, the determining whether the voice feedback satisfies a preset condition includes: sending the voice feedback to the server, the server being configured to determine whether the voice feedback satisfies the preset condition; and receiving the determination result returned by the server

In some embodiments, the server stores a video set, and a video in the video set includes at least one image frame associated with a time node. The video in the video set is generated by: acquiring an original video uploaded by a content provider, the original video including at least one image frame; acquiring at least one piece of time node description information submitted by the content provider aiming at the original video, the time node description information including an image frame identifier and voice interactive content; for a piece of time node description information in the at least one piece of time node description information, creating a time node corresponding to the piece of time node description information, and associating the created time node with an image frame represented by an image frame identifier in the piece of time node description information, to trigger an operation for acquiring voice interactive content in the piece of time node description information when the image frame is played; and adding the original video associated with the time node to the video set to be used as the video in the video set.

In a second aspect, the embodiments of the present disclosure provide a method for playing a video applied on a server. The method includes: receiving a voice interactive content acquisition request sent by a smart device, the voice interactive content acquisition request being sent in a situation where the smart device detects a target video is played to an image frame associated with a time node and pauses playing of the target video, the voice interactive content acquisition request including an identifier of the time node, and the target video being acquired by the smart device from a server in response to receiving a video playing voice command in a form of voice; determining voice interactive content corresponding to the identifier of the time node; and sending the determined voice interactive content to the smart device, to cause the smart device to play the received voice interactive content.

In some embodiments, the method further includes: receiving voice feedback sent by the smart device on the played voice interactive content; determining whether the voice feedback satisfies a preset condition; and sending the determination result to the smart device.

In some embodiments, the server stores a video set, and a video in the video set includes at least one image frame associated with a time node. The method further includes: acquiring an original video uploaded by a content provider, the original video including at least one image frame; acquiring at least one piece of time node description information submitted by the content provider aiming at the original video, the time node description information including an image frame identifier and voice interactive content; creating, for a piece of time node description information in the at least one piece of time node description information, a time node corresponding to the piece of time node description information, and associating the created time node with an image frame represented by an image frame identifier in the piece of time node description information, to trigger an operation for acquiring voice interactive content in the piece of time node description information when the image frame is played; and adding the original video associated with the time node to the video set.

In a third aspect, the embodiments of the present disclosure provide an apparatus for playing a video applied on a smart device. The apparatus includes: a video pausing unit, configured to pause, in response to detecting a target video being played to an image frame associated with a time node, playing of the target video, the target video being acquired by a smart device from a server in response to receiving a video playing voice command in a form of voice; a request sending unit, configured to send to the server a request for acquiring voice interactive content corresponding to the time node; a content receiving unit, configured to receive the voice interactive content returned by the server; and a content playing unit, configured to play the received voice interactive content.

In some embodiments, the apparatus further includes: a feedback receiving unit, configured to receive voice feedback of a user on the played voice interactive content; a condition determining unit, configured to determine whether the voice feedback satisfies a preset condition; and a video playing unit, configured to continue, in response to determining the voice feedback satisfying the preset condition, the playing of the target video.

In some embodiments, the apparatus further includes: an operation performing unit, configured to perform a preset operation in response to determining the voice feedback not satisfying the preset condition.

In some embodiments, the condition determining unit includes an information sending module, configured to send the voice feedback to the server, the server being configured to determine whether the voice feedback satisfies the preset condition; and a result receiving module, configured to receive the determination result returned by the server.

In some embodiments, the server stores a video set, and a video in the video set includes at least one image frame associated with a time node. The video in the video set is generated by: acquiring an original video uploaded by a content provider, the original video including at least one image frame; acquiring at least one piece of time node description information submitted by the content provider aiming at the original video, the time node description information including an image frame identifier and voice interactive content; for a piece of time node description information in the at least one piece of time node description information, creating a time node corresponding to the piece of time node description information, and associating the created time node with an image frame represented by an image frame identifier in the piece of time node description information, to trigger an operation for acquiring voice interactive content in the piece of time node description information when the image frame is played; and adding the original video associated with the time node to the video set to be used as the video in the video set.

In a fourth aspect, the embodiments of the present disclosure provide an apparatus for playing a video applied on a server. The apparatus includes: a request receiving unit, configured to receive a voice interactive content acquisition request sent by a smart device, the voice interactive content acquisition request being sent in a situation where the smart device detects a target video is played to an image frame associated with a time node and pauses playing of the target video, the voice interactive content acquisition request including an identifier of the time node, and the target video being acquired by the smart device from a server in response to receiving a video playing voice command in a form of voice; a content determining unit, configured to determine voice interactive content corresponding to the identifier of the time node; and a content sending unit, configured to send the determined voice interactive content to the smart device, to cause the smart device to play the received voice interactive content.

In some embodiments, the apparatus further includes: an information receiving unit, configured to receive voice feedback sent by the smart device on the played voice interactive content; a condition determining unit, configured to determine whether the voice feedback satisfies a preset condition; and a result sending unit, configured to send the determination result to the smart device.

In some embodiments, the server stores a video set, and a video in the video set includes at least one image frame associated with a time node. The apparatus further includes: a video acquiring unit, configured to acquire an original video uploaded by a content provider, the original video including at least one image frame; a node information acquiring unit, configured to acquire at least one piece of time node description information submitted by the content provider aiming at the original video, the time node description information including an image frame identifier and voice interactive content; an associating unit, configured to create, for a piece of time node description information in the at least one piece of time node description information, a time node corresponding to the piece of time node description information, and associate the created time node with an image frame represented by an image frame identifier in the piece of time node description information, to trigger an operation for acquiring voice interactive content in the time node description information when the image frame is played; and a video adding unit, configured to add the original video associated with the piece of time node to the video set.

In a fifth aspect, the embodiments of the present disclosure provide an electronic device. The electronic device includes: one or more processors; and a storage device, configured to store one or more programs. The one or more programs, when executed by the one or more processors, cause the one or more processors to implement the method described in any implementation in the first aspect or the method described in any implementation in the second aspect.

In a sixth aspect, the embodiments of the present disclosure provide a computer readable medium storing a computer program. The program, when executed by a processor, implements the method described in any implementation in the first aspect or the method described in any implementation in the second aspect.

According to the method and apparatus for playing a video provided by the embodiments of the present disclosure, the smart device pauses the playing of the target video when detecting that the target video is played to the image frame associated with the time node, then sends to the server the request for acquiring the voice interactive content and receives the voice interactive content returned by the server, and finally plays the interactive content. Thus, the interactive interaction with the user performed through a dialogue is implemented during the playing of the video.

### BRIEF DESCRIPTION OF THE DRAWINGS

After reading detailed descriptions of non-limiting embodiments given with reference to the following accompanying drawings, other features, objectives and advantages of the present disclosure will be more apparent:

FIG. 1 is a diagram of an exemplary system architecture in which an embodiment of the present disclosure may be applied;

FIG. 2 is a flowchart of an embodiment of a method for playing a video applied on a smart device according to the present disclosure;

FIGS. 3A and 3B are schematic diagrams of an application scenario of the method for playing a video applied on a smart device according to the present disclosure;

FIG. 4 is a flowchart of an embodiment of a method for playing a video applied on a server according to the present disclosure;

FIG. 5 is a schematic structural diagram of an embodiment of an apparatus for playing a video applied on a smart device according to the present disclosure;

FIG. 6 is a schematic structural diagram of an embodiment of an apparatus for playing a video applied on a server according to the present disclosure; and

FIG. 7 is a schematic structural diagram of a computer system adapted to implement an electronic device according to the embodiments of the present disclosure.

### DETAILED DESCRIPTION OF EMBODIMENTS

The present disclosure will be described below in detail with reference to the accompanying drawings and in combination with the embodiments. It should be appreciated that the specific embodiments described herein are merely used for explaining the relevant invention, rather than limiting the invention. In addition, it should be noted that, for the ease of description, only the parts related to the relevant invention are shown in the accompanying drawings.

It should also be noted that the embodiments in the present disclosure and the features in the embodiments may be combined with each other on a non-conflict basis. The present disclosure will be described below in detail with reference to the accompanying drawings and in combination with the embodiments.

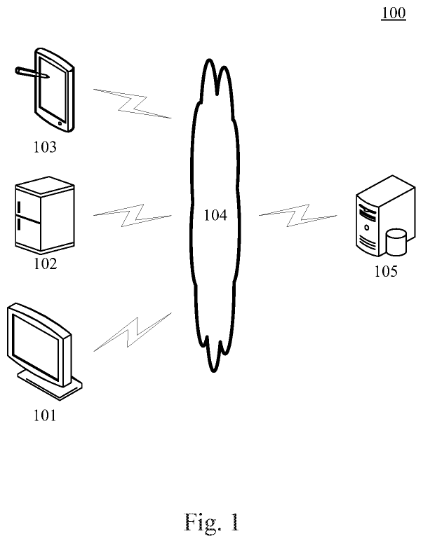

FIG. 1 shows an exemplary system architecture 100 in which a method for playing a video applied on a smart device, a method for playing a video applied on a server, an apparatus for playing a video applied on a smart device, or an apparatus for playing a video applied on a server according to an embodiment of the present disclosure may be applied.

As shown in FIG. 1, the system architecture 100 may include smart devices 101, 102 and 103, a networks 104 and a server 105. The network 104 serves as a medium providing a communication link between the smart devices 101, 102 and 103 and the server 105. The network 104 may include various types of connections, for example, wired or wireless communication links, or optical fiber cables.

A user may operate the smart devices 101, 102 and 103 through a natural language dialogue to interact with the server 105 via the network 104, to receive or send a message or the like. Various communication client applications (e.g., video playing applications, web browser applications, shopping applications, search applications, instant communication tools, mailbox clients and social platform software) may be installed on the smart devices 101, 102 and 103.

The smart devices 101, 102 and 103 may be hardware or software. When being hardware, the smart devices 101, 102 and 103 may be various electronic devices having a display screen and support ng a dialogue interaction and a video playback, which include, but not limited to, a smart phone, a tablet computer, a smart air conditioner, a smart refrigerator and a smart television. When being software, the smart devices 101, 102 and. 103 may be installed in the above listed electronic devices. The smart devices may be implemented as a plurality of pieces of software or a plurality of software modules (e.g., software or software modules for providing a distributed service), or as a single piece of software or a single software module, which will not be specifically defined here.

The server 105 may be a server providing various services, for example, a backend server providing a support for a video played on the smart devices 101, 102 and 103. The backend server may process received data such as a voice content acquisition request, and feed the processing result (e.g., voice interactive content) back to the smart devices.

It should be noted that the method for playing a video applied on a smart device provided by the embodiments of the present disclosure is generally performed by the smart devices 101, 102 and 103. Correspondingly, the apparatus for playing a video applied on a smart device is generally provided in the smart devices 101, 102 and 103. The method for playing a video applied on a server provided by the embodiments of the present disclosure is generally performed by the server 105. Correspondingly, the apparatus for playing a video applied on a server is generally provided in the server 105.

It should be noted that the server 105 may be hardware or software. When being hardware, the server 105 may be implemented as a distributed server cluster composed of a plurality of servers, or as a single server. When being software, the server 105 may be implemented as a plurality of pieces of software or a plurality of software modules (e.g., software or software modules for providing a distributed service), or as a single piece of software or a single software module, which will not be specifically defined here.

It should be appreciated that the numbers of the smart devices, the networks, and the servers in FIG. 1 are merely illustrative. Any number of smart devices, networks, and servers may be provided based on actual requirements.

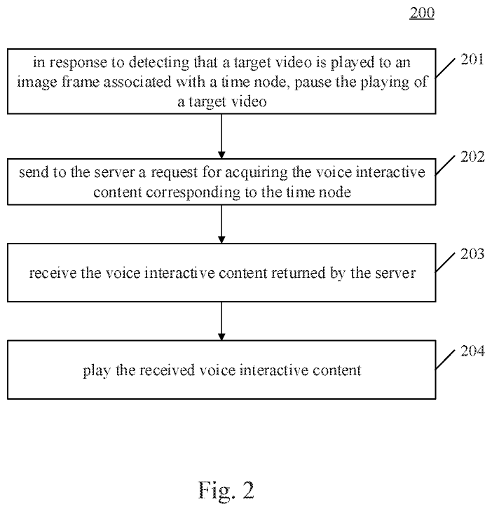

Further referring to FIG. 2, a flow 200 of an embodiment of a method for playing a video applied on a smart device according to the present disclosure is illustrated. The method for playing a video applied on a smart device includes the following steps:

Step 201, pausing, in response to detecting a target video being played to an image frame associated with a time node, playing of the target video.

In this embodiment, an executor (e.g., the smart devices 101, 102 and 103 shown in FIG. 1) of the method for playing a video applied on a smart device may detect whether the target video played on a smart device is played to the image frame associated with a time node. If yes, the playing of the target video is paused. Where, in response to receiving a video playing voice command in a form of voice (e.g., “playing a video of manually making a fire truck”), the smart device acquires the target video from a server (e.g., the server 105 in FIG. 1). Here, the time node may be a tag or a mark for indicating a time (or an image frame corresponding to the time) in the target video at which a voice interaction with the user is required. The voice interaction may refer to an interactive interaction performed in the form of voice between a smart terminal and the user, for example, a dialogue performed in a natural language.

As an example, the target video “video of manually making a fire truck” includes 100 image frames, and the 1^{st} to the 35^{th} image frame in the target video are a demonstration of making the head of the truck. In order to determine whether the user has learned how to make the head of the truck, the content provider of the target video needs to associate a time node for triggering a voice interaction at the 35^{th} image frame of the target video. When the target video is played to the image frame (i.e., the 35^{th} image frame) associated with the time node, the smart device triggers the voice interactive operation which will be described below, and may pause the playing of the target video “video of manually making a fire truck.”

Step 202, sending a request for acquiring voice interactive content corresponding to the time node to a server.

In this embodiment, the executor may send to the server the voice interactive content acquisition request by means of a wired connection or a wireless connection, to acquire the voice interactive content corresponding to the time node. The voice interactive content acquisition request may include an identifier of the time node. Here, the voice interactive content refers to the content of the voice interaction to be performed between the smart terminal and the user, for example, “Do you understand what I just said?” and “What steps are involved in making the front of the truck?.”

It should be noted that the wireless connection may include, but not limited to, a 3G (the 3rd generation)/4G (the 4th generation)/5G (the 5th generation) communication connection, a WiFi (Wireless-Fidelity) connection, a Bluetooth connection, a WiMAX (Worldwide Interoperability for Microwave Access) connection, a Zigbee (also known as Zigbee protocol) connection, an UWB (ultra wideband) connection, and other wireless connections now known or developed in the future.

Step 203, receiving the voice interactive content returned by the server.

In this embodiment, the executor may receive the voice interactive content returned by the server. The voice interactive content is locally or remotely acquired by the server based on the identifier of the time node in the voice interactive content acquisition request.

Step 204, playing the received voice interactive content.

In this embodiment, the executor may play the voice interactive content received in step 203 in the form of voice. For example, the smart device may ask the user through a natural language dialogue: “Do you understand what I just said?.”

In some alternative implementations of this embodiment, the method for playing a video applied on a smart device may further include the following steps:

First, the executor may receive voice feedback of the user on the voice interactive content played by the smart device. For example, when the smart device plays the voice interactive content. “Do you understand what I just said?,” the user may feedback “I understand” in voice.

Then, the executor may determine whether the received voice feedback satisfies a preset condition. Here, the preset condition refers to a preset condition for determining whether the voice feedback of the user achieves an expected effect. Taking the target video “video of manually making a fire truck” as an example, for the voice interaction at the 35^{th} image frame, the preset condition may be that the voice feedback includes “understanding” or information having similar semantics. When the received voice feedback is “I understand,” it may be determined that the received voice feedback satisfies the preset condition. When the received voice feedback is “I don't understand,” it may be determined that the received voice feedback does not satisfy the preset condition.

Finally, the executor may perform a corresponding operation according to whether the received voice feedback satisfies the preset condition.

In some examples, in a situation where the received voice information (e.g., “I understand”) satisfies the preset condition, the executor may continue to play the target video.

In some other examples, in a situation where the received voice information (e.g., “I don't understand”) does not satisfy the preset condition, the executor may perform a preset operation. Here, the preset operation may include an operation to be performed by the smart device in a situation where the voice feedback of the user does not achieve the expected effect. For example, replaying the demonstration of making the head of the truck.

Although the above implementations describe that whether the received voice feedback satisfies the condition is determined by the smart device, the present disclosure is not limited thereto.

In some alternative implementations of this embodiment, determining whether the voice feedback satisfies the preset condition may include: sending the voice feedback to the server, the server being configured to determine whether the voice feedback satisfies the preset condition; and receiving the determination result returned by the server.

In some alternative implementations of this embodiment, the server may store a video set. Each video in the video set may include at least one image frame associated with a time node. The video in this video set generated through the following steps.

First, an original video uploaded by a content provider (also referred to as a developer) is acquired, the original video including at least one image frame.

Next, at least one piece of time node description information submitted by the content provider aiming at the original video by the content provider is acquired, the time node description information including an image frame identifier and voice interactive content. As an example, after the original video is uploaded, an editing interface for the original video may be provided to the content provider, and the content provider may select an image frame at which the smart device needs to interact with the user through the provided interface and provide the voice interactive content.

Then, for a piece of time node description information in the at least one piece of time node description information, a time node corresponding to the piece of time node description information is created (for example, a time tag or a time mark is created), and the created time node is associated with the image frame represented by the image frame identifier in the piece of time node description information, to trigger an operation for acquiring voice interactive content in the piece of time node description information when the image frame is played. Here, associating the time node with the image frame may refer to that the time node is added to the image frame, or that a substantive change may not be performed on the image frame as long as the smart device can detect the corresponding time node through the image frame. The association will not be specifically defined in the present disclosure.

Finally, the original video associated with the time node is added to the video set to be used as the video in the video set.

It should be understood that the executor executing the above described steps of generating the video in the video set may be the server receiving the voice interactive content acquisition request, or other servers (for example, the other servers generate the video set, and then store the video set on the server receiving the voice interactive content acquisition request), which will not be specifically defined in the present disclosure.

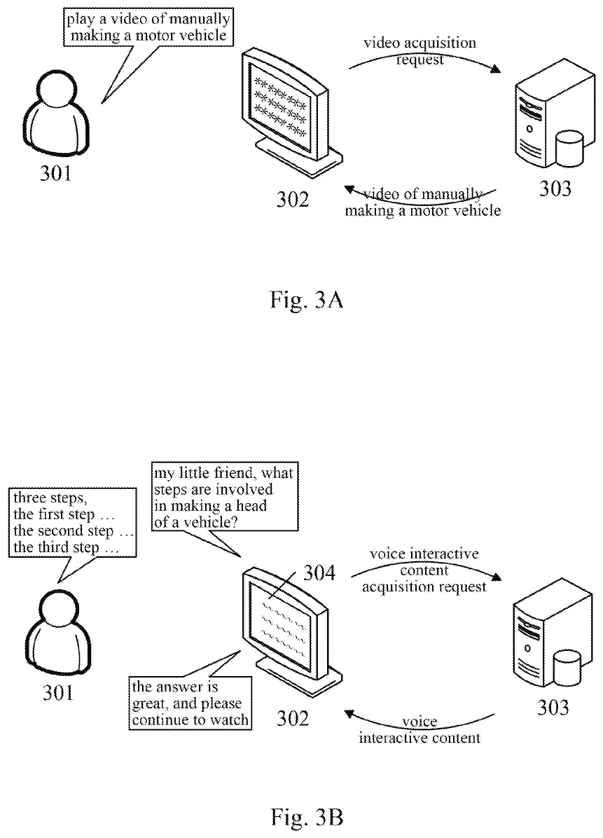

Further referring to FIGS. 3A and 3B, an application scenario of the method for playing a video applied on a smart device according to the present disclosure is illustrated. In FIG. 3A, first the user 301 issues the voice command “play a video of manually making a motor vehicle.” Then, the smart television 302 sends a video acquisition request to the server 303, and receives the video “video of manually making a motor vehicle” returned by the server 303 and plays the video. In FIG. 3B, when detecting that the video “video of manually making a motor vehicle” is played to the image frame 304 associated with a time node, the smart device 302 pauses the playing of the video “video of manually making a motor vehicle,” and sends a voice interactive content acquisition request to the server 303. Then, the smart device 304 receives the voice interactive content returned by the server 303, and plays the voice interactive content for the user 301: “my little friend, what steps are involved in making a head of a vehicle?.” After hearing the question, the user 301 may answer: “three steps, the first step . . . the second step . . . the third step . . . .” If the answer of the user contains a preset key point, the smart device 302 may give the voice prompt “the answer is great, and please continue to watch,” and continue to play the video “video of manually making a motor vehicle,” thus achieving the voice interaction between the smart device and the user during the playing of the video.

In the method for playing a video applied on a smart device provided by the foregoing embodiment of the present disclosure, when detecting that the target video is played to an image frame associated with a time node, the smart device pauses the playing of the target video, and then, sends the request to the server to acquire the voice interactive content and receives the voice interactive content returned by the server, and finally plays the interactive content. Thus, the interactive interaction with the user performed through a dialogue is implemented during the playing of the video.

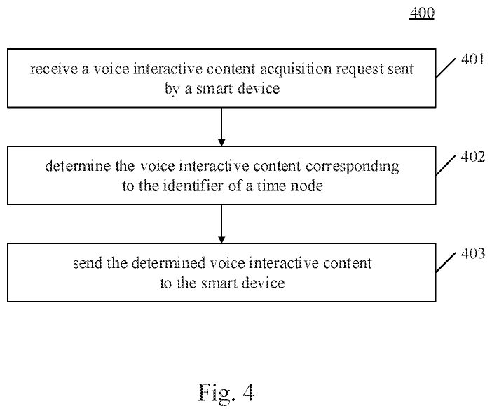

Further referring to FIG. 4, a flow 400 of an embodiment of a method for playing a video applied on a server according to the present disclosure is illustrated. The method for playing a video applied on a server includes the following steps.

Step 401, receiving a voice interactive content acquisition request sent by a smart device.

In this embodiment, an executor (e.g., the server 105 in FIG. 1) of the method for playing a video applied on a server may receive the voice interactive content acquisition request sent by the smart device (e.g., the smart devices 101, 102 and 103 in FIG. 1) by means of a wired connection or a wireless connection. The voice interactive content acquisition request is sent in a situation where the smart device detects that a target video is played to an image frame associated with a time node and pauses the playing of the target video. The voice interactive content acquisition request may include an identifier of a time node. Here, the time node may be a tag or a mark for indicating a time (or an image frame corresponding to the time) in the target video at which a voice interaction with the user is required. In response to receiving a video playing voice command in a form of voice (e.g., “play a video of manually making a fire truck”), the smart device acquires the target video from the server.

Step 402, determining voice interactive content corresponding to an identifier of a time node.

In this embodiment, the executor may locally or remotely acquire the voice interactive content corresponding to the identifier in the voice interactive content acquisition request received in step 401. Here, the voice interactive content refers to the content of the voice interaction between the smart terminal and the user, for example, “Do you understand what I just said?” and “What steps are involved in making the front of the truck?.”

Step 403, sending the determined voice interactive content to the smart device.

In this embodiment, the executor may send the voice interactive content determined in step 402 to the smart device, so that the smart device may play the received voice interactive content in a manner of the natural language dialogue.

In some alternative implementations of this embodiment, the method for playing a video applied on a server may further include the following steps.

First, the executor may receive voice feedback sent by the smart device on the played voice interactive content. The voice feedback is fed back by the user on the voice interactive content played by the smart terminal. For example, when the smart device plays the voice interactive content “Do you understand what I just said?,” the user may feedback “I understand” in voice.

Then, the executor may determine whether the received voice feedback satisfies a preset condition. Here, the preset condition refers to a preset condition for determining whether the voice feedback of the user achieves an expected effect. For example, the preset condition may refer to “understanding” or information having similar semantics. When the received voice feedback is “I understand,” it may be determined that the received voice feedback satisfies the preset condition. When the received voice feedback is “I don't understand,” it may be determined that the received voice feedback does not satisfy the preset condition.

Finally, the executor may send the determination result to the smart device, so that the smart device may perform a corresponding operation (e.g., an operation of continuing to play the target video) according to the determination result.

In some alternative implementations of this embodiment, the server may store a video set. A video in the video set may include at least, one image frame associated with a time node. The method for playing a video for a server may further include the following steps.

First, the executor may acquire an original video uploaded by a content provider (also referred to as a developer), the original video including at least one image frame.

Next, the executor may acquire at least one piece of time node description information submitted by the content provider aiming at the original video, the time node description information including an image frame identifier and voice interactive content. As an example, after the original video is uploaded, an editing interface for the original video may be provided to the content provider, and the content provider may select an image frame at which the smart device needs to interact with the user through the provided interface and provide the voice interactive content.

Then, for a piece of time node description information in the at least one piece of time node description information, the executor may create a time node corresponding to the piece of time node description information (for example, create a time tag or a time mark), and associate the created time node with the image frame represented by the image frame identifier in the piece of time node description information, to trigger an operation for acquiring the voice interactive content in the piece of time node description information when the image frame is played.

Finally, the executor may add the original video associated with the time node to the video set.

In the method for playing a video applied on a server provided by the foregoing embodiment of the present disclosure, by receiving the voice interactive content acquisition request sent in the situation where the smart device detects that the target video is played to the image frame associated with a time node and pauses the playing of the target video, and then, determining the voice interactive content corresponding to the identifier of the time node in the voice interactive content acquisition request, and sending the determined voice interactive content to the smart device, the interactive interaction performed through the dialogue between the smart device and the user is implemented during the playing of the video.

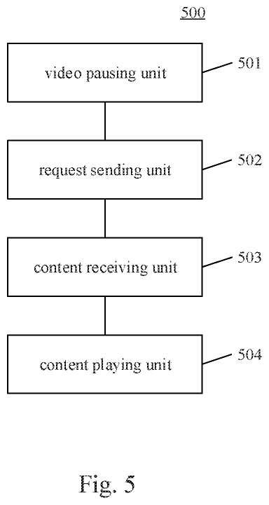

Further referring to FIG. 5, as an implementation of the method shown in FIG. 2, the present disclosure provides an embodiment of an apparatus for playing a video applied on a smart device. The embodiment of the apparatus corresponds to the embodiment of the method shown in FIG. 2, and the apparatus may be applied in a smart device.

As shown in FIG. 5, the apparatus 500 for playing a video applied on a smart device in this embodiment may include: a video pausing unit 501, a request sending unit 502, a content receiving unit 503, and a content playing unit 504. The video pausing unit 501 is configured to pause, in response to detecting a target video being played to an image frame associated with a time node, playing of the target video, the target video being acquired by a smart device from a server in response to receiving a video playing voice command in a form of voice. The request sending unit 502 is configured to send to a server a request for acquiring voice interactive content corresponding to the time node. The content receiving unit 503 is configured to receive the voice interactive content returned by the server. The content playing unit 504 is configured to play the received voice interactive content.

In this embodiment, the video pausing unit 501 in the apparatus 500 for playing a video applied on a smart device may detect whether the target video played on a smart device (e.g., the smart devices 101, 102 and 103) is played to the image frame associated with a time node. If the target video is played to a image frame, the playing of the target video is paused. Here, in.response to receiving the video playing voice command in the form of voice (e.g., “play a video of manually making a fire truck”), the smart device acquires the target video from the server (e.g., the server 105 in FIG. 1). Here, the time node may be a tag or a mark for indicating a time (or an image frame corresponding to the time) in the target video at which a voice interaction with the user is required.

In this embodiment, the request sending unit 502 may send the request for acquiring the voice interactive content to the server by means of a wired connection or a wireless connection, to acquire the voice interactive content corresponding to the time node. The voice interactive content acquisition request may include the identifier of the above time node. Here, the voice interactive content refers to the content of the voice interaction between the smart terminal and the user, for example, “Do you understand what I just said?” and “What steps are involved in making the front of the truck?.”

In this embodiment, the content receiving unit 503 may receive the voice interactive content returned by the server. The voice interactive content is locally or remotely acquired by the server based on the identifier of the time node in the voice interactive content acquisition request.

In this embodiment, the content playing unit 504 may play the voice interactive content received by the content receiving unit 503 in the form of voice. For example, the smart device may ask the user through a natural language dialogue: “Do you understand what I just said?.”

In some alternative implementations of this embodiment, the apparatus 500 may further include: a feedback receiving unit, a condition determining unit and a video playing unit. The feedback receiving unit is configured to receive voice feedback of the user on the played voice interactive content. The condition determining unit is configured to determine whether the voice feedback satisfies a preset condition. The video playing unit is configured to continue, in response to determining the voce feedback satisfying the preset condition, the playing of the target video.

In some alternative implementations of this embodiment, the apparatus 500 may further include: an operation performing unit. The operation performing unit is configured to perform, in response to determining the voice feedback not satisfying the preset condition, a preset operation.

In some alternative implementations of this embodiment, the condition determining unit may include an information sending module and a result receiving module. The information sending module is configured to send the voice feedback to the server, the server being configured to determine whether the voice feedback satisfies the preset condition. The result receiving module is configured to receive the determination result returned by the server.

In some alternative implementations of this embodiment, the server may store a video set, and a video in the video set may include at least one image frame associated with a time node. The a video in the video set may be generated by: acquiring an original video uploaded by a content provider, the original video including at least one image frame; acquiring at least one piece of time node description information submitted by the content provider aiming at the original video, the time node description information including an image frame identifier and voice interactive content; for a piece of time node description information in the at least one piece of time node description information, creating a time node corresponding to the piece of time node description information, and associating the created time node with an image frame represented by an image frame identifier in the piece of time node description information, to trigger an operation for acquiring voice interactive content, in the piece of time node description information when the image frame is played; and adding the original video associated with the time node to the video set to be used as the video in the video set.

According to the apparatus for playing a video applied on a smart device provided by the embodiments of the present disclosure, the smart device pauses the playing of the target video when detecting that the target video is played to the image frame associated with a time node, then sends the request for acquiring the voice interactive content to the server and receives the voice interactive content returned by the server, and finally plays the interactive content. Thus, the interactive interaction with. the user performed through a dialogue is implemented during the playing of the video.

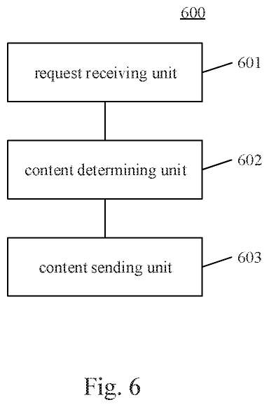

Further referring to FIG. 6, as an implementation of the method shown in FIG. 4, the present disclosure provides an embodiment of an apparatus for playing a video applied on a server. The embodiment of the apparatus corresponds to the embodiment of the method shown in FIG. 4, and the apparatus may be applied in a server.

As shown in FIG. 6, 6, the apparatus 600 for playing a video applied on a server in this embodiment includes: a request receiving unit 601, a content determining unit 602, and a content sending unit 603. The request receiving unit 601 is configured to receive a voice interactive content acquisition request sent by a smart device. The voice interactive content acquisition request is sent in a situation where the smart device detects that a target video is played to an image frame associated with a time node and pauses the playing of the target video. The voice interactive content acquisition request includes an identifier of the time node, and the target video is acquired by the smart device from a server in response to receiving a video playing voice command in a form of voice. The content determining unit 602 is configured to determine voice interactive content corresponding to the identifier of the time node. The content sending unit 603 is configured to send the determined voice interactive content to the smart device, to cause the smart device to play the received voice interactive content.

In this embodiment, the request receiving unit 601 in the apparatus 600 for playing a video applied on a server may receive the voice interactive content acquisition request sent by the smart device (e.g., the smart devices 101, 102 and 103 in FIG. 1) by means of a wired connection or a wireless connection. The voice interactive content acquisition request is sent in a situation where the smart device detects that the target video is played to an image frame associated with a time node and pauses the playing of the target video. The voice interactive content acquisition request may include the identifier of the time node. Here, the time node may be a tag or a mark for indicating a time (or an image frame corresponding to the time) in the target video at which a voice interaction with the user is required. In response to receiving the video playing voice command in the form or voice (e.g., “playing a video of manually making a fire truck”) , the smart device acquires the target video from the server (e.g., the server 105 in FIG. 1).

In this embodiment, the content determining unit 602 in the apparatus 600 for playing a video applied on a server may locally or remotely acquire the voice interactive content corresponding to the identifier in the voice interactive content acquisition request received by the request receiving unit 601. Here, the voice interactive content refers to the content of the voice interaction between the smart terminal and the user, for example, “Do you understand what I just said?” and “What steps are involved in making the front of the truck?.”

In this embodiment, the content sending unit 603 in the apparatus 600 for playing a video applied on a server may send the voice interactive content determined by the content determining unit 602 to the smart device, so that the smart device may play the received voice interactive content through a natural language dialogue.

In some alternative implementations of this embodiment, the apparatus 600 for playing a video for a server may further include: an information receiving unit, a condition determining unit and a result sending unit. The information receiving unit is configured to receive voice feedback sent by the smart device on the played voice interactive content. The condition determining unit is configured to determine whether the voice feedback satisfies a preset condition. The result sending unit is configured to send the determination result to the smart device.

In some alternative implementations of this embodiment, the server stores a video set, and a video in the video set includes at least one image frame associated with a time node. The apparatus 600 for playing a video applied on a server may further include: a video acquiring unit, a node information acquiring unit, an associating unit and a video adding unit. The video acquiring unit is configured to acquire an original video uploaded by a content provider, the original video including at least one image frame. The node information acquiring unit is configured to acquire at least one piece of time node description information submitted by the content provider aiming at the original video, the time node description information including an image frame identifier and voice interactive content. The associating unit is configured to create, for a piece of time node description information in the at least one piece of time node description information, a time node corresponding to the piece of time node description information, and associate the created time node with an image frame represented by an image frame identifier in the piece of time node description information, to trigger an operation for acquiring voice interactive content in the piece of time node description information when the image frame is played. The video adding unit is configured to add the original video associated with the time node to the video set.

According to the apparatus for playing a video for a server provided by the foregoing embodiment of the present disclosure, by receiving the voice interactive content acquisition request sent in the situation where the smart device detects that the target video is played to the image frame associated with a time node and pauses the playing of the target video, and then determining the voice interactive content corresponding to the identifier of the time node in the voice interactive content acquisition request, and sending the determined voice interactive content to the smart device, the interactive interaction performed through the dialogue between the smart device and the user is implemented during the playing of the video.

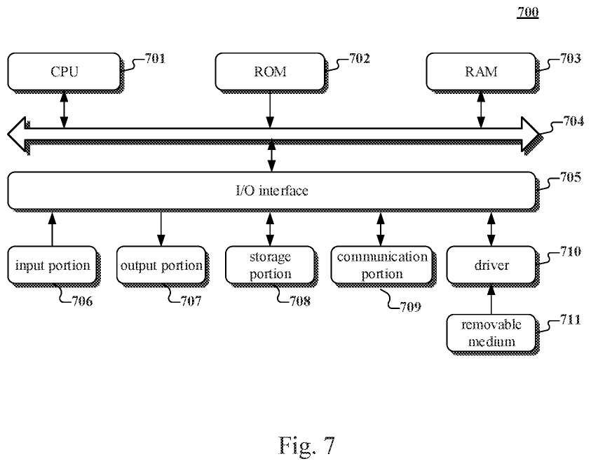

Referring to FIG. 7, FIG. 7 illustrates a schematic structural diagram of a computer system 700 adapted to implement an electronic device (e.g., the smart devices 101, 102 and 103 or the server 105 shown in FIG. 1) of the embodiments of the present disclosure. The electronic device shown in FIG. 7 is merely an example and should not impose any restriction on the function and scope of use of the embodiments of the present disclosure.

As shown in FIG. 7, the computer system 700 includes a central processing unit. (CPU) 701, which may execute various appropriate actions and processes in accordance with a program stored in a read-only memory (ROM) 702 or a program loaded into a random access memory (RAM) 703 from a storage portion 708. The RAM 703 further stores various programs and data required by operations of the system 700. The CPU 701, the ROM 702 and the RAM 703 are connected to each other via a bus 704. An input/output (I/O) interface 705 is also connected to the bus 704.

The following components are connected to the I/O interface 705: an input portion 706 including a microphone etc.; an output portion 707 including an organic light-emitting diode (OLED) display, a liquid crystal display (LCD), a speaker, etc.; a storage portion 708 including a hard disk and the like; and a communication portion 709 including a network interface card, for example, a LAN card and a modem. The communication portion 709 performs communication processes via a network such as the Internet. A driver 710 is also connected to the I/O interface 705 as required. A removable medium 711, for example, a magnetic disk, an optical disk, a magneto-optical disk, and a semiconductor memory, may be installed on the driver 710, to facilitate the installation of a computer program from the removable medium 711 on the storage portion 708 as needed.

In particular, according to the embodiments of the present disclosure, the process described above with reference to the flowchart may be implemented as a computer software program. For example, an embodiment of the present disclosure includes a computer program product, including a computer program hosted on a computer readable medium, the computer program including program codes for performing the method as illustrated in the flowchart. In such an embodiment, the computer program may be downloaded and installed from a network via the communication portion 709, and/or may be installed from the removable medium 711. The computer program, when executed by the central processing unit (CPU) 701, implements the above mentioned functionalities as defined by the method of the present disclosure.

It should be noted that the computer readable medium in the present disclosure may be a computer readable signal medium, a computer readable storage medium, or any combination of the two. For example, the computer readable storage medium may be, but not limited to: an electronic, magnetic, optical, electromagnetic, infrared, or semiconductor system, apparatus, or element, or any combination of the above. A more specific example of the computer readable storage medium may include, but not limited to: an electrical connection having one or more wires, a portable computer disk, a hard disk, a random access memory (RAM), a read only memory (ROM), an erasable programmable read only memory (EPROM or flash memory), a fiber, a portable compact disk read only memory (CD-ROM), an optical memory, a magnet memory or any suitable combination of the above. In the present disclosure, the computer readable storage medium may be any physical medium containing or storing programs, which may be used by a command execution system, apparatus or element or incorporated thereto. In the present disclosure, the computer readable signal medium may include a data signal that is propagated in a baseband or as a part of a carrier wave, which carries computer readable program codes. Such propagated data signal may be in various forms, including, but not limited to, an electromagnetic signal, an optical signal, or any suitable combination of the above. The computer readable signal medium may also be any computer readable medium other than the computer readable storage medium. The computer readable medium is capable of transmitting, propagating or transferring programs for use by, or used in combination with, a command execution system, apparatus or element. The program codes contained on the computer readable medium may be transmitted with any suitable medium including, but not limited to, wireless, wired, optical cable, RF medium, or any suitable combination of the above.

A computer program code for executing the operations according to the present disclosure may be written in one or more programming languages or a combination thereof. The programming language includes an object-oriented programming language such as Java, Smalltalk and C++, and further includes a general procedural programming language such as “C” language or a similar programming language. The program codes may be executed entirely on a user computer, executed partially on the user computer, executed as a standalone package, executed partially on the user computer and partially on a remote computer, or executed entirely on the remote computer or a server. When the remote computer is involved, the remote computer may be connected to the user computer through any type of network, including a local area network (LAN) or a wide area network (WAN), or be connected to an external computer (e.g., connected through Internet provided by an Internet service provider).

The flowcharts and block diagrams in the accompanying drawings illustrate architectures, functions and operations that may be implemented according to the system, the method, and the computer program product of the various embodiments of the present disclosure. In this regard, each of the blocks in the flowcharts or block diagrams may represent a module, a program segment, or a code portion, the module, the program segment, or the code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be executed in a reverse sequence, depending on the function involved. It should also be noted that each block in the block diagrams and/or flowcharts as well as a combination of blocks may be implemented using a dedicated hardware-based system executing specified functions or operations, or by a combination of dedicated hardware and computer instructions.

The units involved in the embodiments of the present disclosure may be implemented by means of software or hardware. The described units may also be provided in a processor, for example, described as: a processor, comprising a video pausing unit, a request sending unit, a content receiving unit, and a content playing unit. The names of these units do not in some cases constitute a limitation to such units themselves. For example, the video pausing unit may also be described as “a unit for pausing, in response to detecting a target video being played to an image frame associated with a time node, playing of the target video.”

In another aspect, the present disclosure further provides a computer readable medium. The computer readable medium may be the computer readable medium included in the smart terminal or the server described in the above embodiments, or a stand-alone computer readable medium not assembled into the smart terminal or the server. The computer readable medium stores one or more programs. The one or more programs, when executed by the smart terminal, cause the smart terminal to: pause, in response to detecting a target video being played to an image frame associated with a time node, playing of the target video, the target video being acquired by a smart device from a server in response to receiving a video playing voice command in a form of voice; send to a server a request for acquiring voice interactive content corresponding to the time node; receive the voice interactive content returned by the server; and play the received voice interactive content. The one or more programs, when executed by the server, cause the server to: receive a voice interactive content acquisition request sent by a smart device, the voice interactive content acquisition request being sent in a situation where the smart device detects a target video is played to an image frame associated with a time node and pauses playing of the target video, the voice interactive content acquisition request including an identifier of the time node, and the target video being acquired by the smart device from a server in response to receiving a video playing voice command in a form of voice; determine voice interactive content corresponding to the identifier of the time node; and send the determined voice interactive content to the smart device, to cause the smart device to play the received voice interactive content.

The above description is only an explanation for the preferred embodiments of the present disclosure and the applied technical principles. It should be appreciated by those skilled in the art that the inventive scope of the present disclosure is not limited to the technical solution formed by the particular combinations of the above technical features. The inventive scope should also cover other technical solutions formed by any combinations of the above technical features or equivalent features thereof without departing from the concept of the invention, for example, technical solutions formed by replacing the features as disclosed in the present disclosure with (but not limited to) technical features with similar functions.

What is claimed is:

1. A method for playing a video, applied on a smart device, comprising:
pausing, in response to detecting a target video being played to an image frame associated with a time node, playing of the target video, the target video being acquired by a smart device from a server in response to receiving a video playing voice command in a form of voice;
sending to the server a request, for acquiring voice interactive content corresponding to the time node;
receiving the voice interactive content returned by the server; and
playing the received voice interactive content.

2. The method according to claim 1, further comprising:
receiving voice feedback of a user on the played voice interactive content;
determining whether the voice feedback satisfies a preset condition; and
continuing, in response to determining the voice feedback satisfying the preset condition, the playing of the target video.

3. The method according to claim 2, further comprising:
performing a preset operation in response to determining the voice feedback not satisfying the preset condition.

4. The method according to claim 2, wherein the determining whether the voice feedback satisfies a preset condition includes:
sending the voice feedback to the server, the server being configured to determine whether the voice feedback satisfies the preset condition; and
receiving the determination result returned by the server.

5. The method according to claim 1, wherein the server stores a video set, a video in the video set includes at least one image frame associated with a time node, and the video in the video set is generated by:
acquiring an original video uploaded by a content provider, the original video including at least one image frame;
acquiring at least one piece of time node description information submitted by the content provider aiming at the original video, the time node description information including an image frame identifier and voice interactive content;
for a piece of time node description information in the at least one piece of time node description information, creating a time node corresponding to the piece of time node description information, and associating the created time node with an image frame represented by an image frame identifier in the piece of time node description information, to trigger an operation for acquiring voice interactive content in the piece of time node description information when the image frame is played; and
adding the original video associated with the time node to the video set to be used as the video in the video set.

6. The method according to claim 2, wherein the server stores a video set, a video in the video set includes at least one image frame associated with a time node, and the video in the video set is generated by:
acquiring an original video uploaded by a content provider, the original video including at least one image frame;
acquiring at least one piece of time node description information submitted by the content provider aiming at the original video, the time node description information including an image frame identifier and voice interactive content;
for a piece of time node description information in the at least one piece of time node description information, creating a time node corresponding to the piece of time node description information, and associating the created time node with an image frame represented by an image frame identifier in the piece of time node description information, to trigger an operation for acquiring voice interactive content in the piece of time node description information when the image frame is played; and
adding the original video associated with the time node to the video set to be used as the video in the video set.

7. A method for playing a video, applied on a server, comprising:
receiving a voice interactive content acquisition request sent by a smart device, the voice interactive content acquisition request being sent in a situation where the smart device detects a target video is played to an image frame associated with a time node and pauses playing of the target video, the voice interactive content acquisition request including an identifier of the time node, and the target video being acquired by the smart device from a server in response to receiving a video playing voice command in a form of voice;
determining voice interactive content corresponding to the identifier of the time node; and
sending the determined voice interactive content to the smart device, to cause the smart device to play the received voice interactive content.

8. The method according to claim 7, further comprising:
receiving voice feedback sent by the smart device on the played voice interactive content;
determining whether the voice feedback satisfies a preset condition; and
sending the determination result to the smart device.

9. The method according to claim 7, wherein the server stores a video set, a video in the video set includes at least one image frame associated with a time node, and
the method further comprises:
acquiring an original video uploaded by a content provider, the original video including at least one image frame;
acquiring at least one piece of time node description information submitted by the content provider aiming at the original video, the time node description information including an image frame identifier and voice interactive content;
for a piece of time node description information in the at least one piece of time node description information, creating a time node corresponding to the piece of time node description information, and associating the created time node with an image frame represented by an image frame identifier in the piece of time node description information, to trigger an operation for acquiring voice interactive content in the piece of time node description information when the image frame is played; and
adding the original video associated with the time node to the video set.

10. An apparatus for playing a video, applied on a smart device, comprising:
at least one processor; and
a memory storing instructions, the instructions when executed by the at least one processor, cause the at least one processor to perform operations, the operations comprising:
pausing, in response to detecting a target video being played to an image frame associated with a time node, playing of the target video, the target video being acquired by a smart device from a server in response to receiving a video playing voice command in a form of voice;
sending to the server a request for acquiring voice interactive content corresponding to the time node;
receiving the voice interactive content returned by the server; and
playing the received voice interactive content.

11. The apparatus according to claim 10, wherein the operations further comprise:
receiving voice feedback of a user on the played voice interactive content;
determining whether the voice feedback satisfies a preset condition; and
continuing, in response to determining the voice feedback satisfying the preset condition, the playing of the target video.

12. The apparatus according to claim 11, wherein the operations further comprise:
performing a preset operation in response to determining the voice feedback not satisfying the preset condition.

13. The apparatus according to claim 11, wherein the determining whether the voice feedback satisfies a preset condition includes:
sending the voice feedback to the server, the server being configured to determine whether the voice feedback satisfies the preset condition; and
receiving the determination result returned by the server.

14. The apparatus according to claim 10, wherein the server stores a video set, a video in the video set includes at least one image frame associated with a time node, and the video in the video set is generated by:
acquiring an original video uploaded by a content provider, the original video including at least one image frame;
acquiring at least one piece of time node description information submitted by the content provider aiming at the original video, the time node description information including an image frame identifier and voice interactive content;
for a piece of time node description information in the at least one piece of time node description information, creating a time node corresponding to the piece of time node description information, and associating the created time node with an image frame represented by an image frame identifier in the piece of time node description information, to trigger an operation for acquiring voice interactive content in the piece of time node description information when the image frame is played; and
adding the original video associated with the time node to the video set to be used as the video in the video set.

15. An apparatus for playing a video, applied on a server, comprising:
at least one processor; and
a memory storing instructions, the instructions when executed by the at least one processor, cause the at least one processor to perform the method of claim 6.

16. A non-transitory computer readable medium, storing a computer program, wherein the program, when executed by a processor, implements the method of claim 1.

17. A non-transitory computer readable medium, storing a computer program, wherein the program, when executed by a processor, implements the method of claim 6.
